(19) United States
(12) Patent Application Publication
(10) Pub. No.: US 2007/0297579 A1
(43) Pub. Date: Dec. 27, 2007

(54) Mobile content management and routing system

(75) Inventor: Jeffrey Tannenbaum, Wayne, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Photcrank, Inc., Wayne, PA (US)

(21) Appl. No.: 11/820,928

(22) Filed: Jun. 21, 2007

Related U.S. Application Data
(60) Provisional application No. 60/815,379, filed on Jun. 21, 2006.

(51) Int. Cl. H04M 11/00

(52) U.S. Cl. 379/88.13

(57) ABSTRACT

Apparatus and method for dynamically merging diverse multimedia content. A wireless mobile handset, communicating with an Image Processing System (IPS) through a cellular network servicing the handset, sends a message of diverse media with instructions either accompanying the message or identifying a space residing in an IPS database having the desired instructions. The IPS dynamically alters the diverse multimedia content in accordance with the instructions and sends the altered message to recipient(s) identified by the sending handset. The instructions may include providing the altered message at a public (or non-public) site accessed by an internet browser.

### CROSS REFERENCE TO RELATED APPLICATION

This application claims priority from U.S. Provisional Application No. 60/815,379 filed on Jun. 21, 2006, which is incorporated by reference as if fully set forth.

### FIELD OF THE INVENTION

The present invention relates to wireless transmission/reception of multimedia content and more particularly to novel method and apparatus for dynamically merging various forms of multimedia content responsive to a subscriber's request and sending the merged multimedia content to recipients selected by the subscriber and/or making the merged multimedia content available through public or non-public sites accessed via the internet.

### BACKGROUND

With the rapid proliferation of Mobile handsets and the widespread adoption of handsets with built-in digital cameras, mobile phone users are capable of generating massive amounts of digital media by using their mobile handset to snap images, exchange images and receive new images via SMS, MMS, e-mail, directly to their handsets.

Currently, images are stored on the handset and used for backgrounds, screensavers and address book entries. Users are also able to send Multimedia Messages containing these images to other handset users and to other email capable devices.

### SUMMARY

The proposed system and method enables mobile handset users to dynamically alter their otherwise static image files by sending the media file to an Image Processing System (IPS), which in-turn dynamically modifies the contents of the media file and sends the modified media file to the instructed recipients. The IPS can be reached by sending a SMS, MMS or E-mail to a publicly known Recipient Address in the form of: an email address, a phone number, virtual phone number or a US Short Code or any other type of internet protocol (IP) routing address.

### BRIEF DESCRIPTION OF THE FIGURES

The present invention will be understood from a consideration of the accompanying detailed description and drawings, wherein like elements are designated by like numerals, and wherein:

FIG. 1 shows developmental views of exemplary multimedia content which are useful in explaining one simplified example of the manner in which diverse multimedia content are dynamically merged in accordance with the principles of the present invention.

FIGS. 2 and 3 show other examples of dynamically merging multimedia content.

FIG. 4 is a simplified schematic diagram of the basic architecture for a mobile content management and routing system embodying the principles of the present invention.

### DETAILED DESCRIPTION OF THE INVENTION AND PREFERRED EMBODIMENTS THEREOF

Definitions

In order to facilitate an understanding of the invention and its operation, the following list of terms is provided:

Address Book

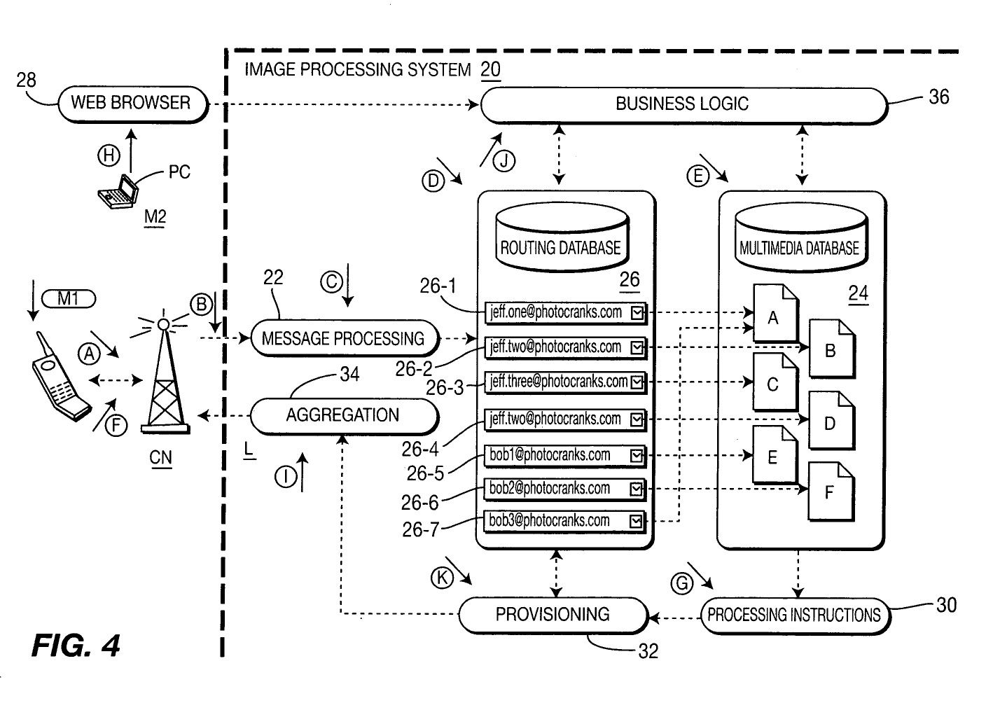

A User's full listing of each of the other Users permitted to have access to their Space and is typically stored in the Routing Database (see 26 in FIG. 4).

Alias

This is a pseudo-name for a User's Space (stored in routing database 26, FIG. 4). A User can create an Alias and furnish this Alias to other Users so they may gain access to the specific Space associated with this Alias. A User may send an Inbound Message (see step A in FIG. 4) to an Alias in the form of [alias]@[IPS Domain] (i.e., a User can choose an Alias name ‘jeff’ and can then have his Space accessible by the email address:jeff@pixFYA.com). When a User sends an Inbound Message (A, FIG. 4) to this Alias, the IPS (20, FIG. 4) processes the Inbound Message and sends a message (dynamically merged with other media content) to as many Recipients as it is instructed. In one such example, the Outbound Processed Message may contain an image of a personal picture of the User who maintains the Alias of ‘Jeff’.

Clip Art

An image stored in any of the common imaging file formats (.jpeg, .png, .bmp, .gif). This image resides on the IPS Routing Database (26, FIG. 4) and is used by the IPS when processing messages. These images can be uploaded to the database by Users. Using the browser, Users access the IPS to select image(s) from the clip art that they want to be combined with images they later send from their wireless handset.

Contact Information

This is the 10-digit phone number or e-mail address used for sending messages to Users. The dynamically altered multimedia content is sent to the recipient identified by this address (see F, FIG. 4).

Groups

Grouped Contact Information that represents, for example, friends, family and business contacts. A User can create different, specific Groups to categorize other Users into.

Image Processing System (IPS)

The entire system (20, FIG. 4) where Inbound Messages (A, FIG. 4) are processed and Outbound Processed Messages (J, F, FIG. 4) are sent out. The IPS includes databases, application code and business logic.

Inbound Image File

This is an image, stored within the Inbound Message (A, FIG. 4) and can reside in any of the popular image file formats.

Inbound Message

This is a message in the format of an SMS, MMS or MIME structure, sent (A, FIG. 4) from a Mobile Device (M1, FIG. 4). This message may contain any combination of the following including but not limited to text, images, sounds bytes, video footage. This message is created by the Mobile Device and sent wirelessly to the Carrier's Network (CN, FIG. 4). The media content accompanying (or instructed to be selected by) the message is relayed to the Recipient Address specified in the message. The Recipient Address may be a US Short Code, a 10-digit phone number or an email address.

MIME

(Multipurpose Internet Mail Extensions) Is an Internet Standard for the format of e-mail. Virtually all e-mail is transmitted via SMTP in MIME format. Mapping messages into and out of MIME format is typically done automatically by the e-mail client or by mail servers.

MMS

(Multimedia Messaging Service) is an enhanced transmission service that enables graphics, video clips and sound files to be transmitted via cell phones (such as M1, FIG. 4).

Mobile Device

This is any form of a wireless handheld device such as, but not limited to, a mobile phone, Blackberry or Personal Digital Assistant (PDA) designed to access a wireless Carrier's network and capable of sending and receiving any of the following message types: SMS; MMS; MIME.

Outbound Processed Message

This is a message that originates from the IPS. (20, FIG. 4) and is preferably in a MIME, SMS or MMS format. This message can have one or more Recipient Address's designated by a 10-digit phone number or an email address. This message may contain any of the following: text (alpha-numeric characters); images file (.jpeg, .bmp, .png, .gif); sound files; video clips.

Processing Instructions

These are instructions that either: originate from a Mobile Device (M1, FIG. 4) and are relayed within an Inbound Message to the IPS (20, FIG. 4); or reside in one of the IPS's databases, having been placed there by a User of the system, or both.

These instructions are composed of a series of alpha-numeric characters, arranged in a pre-determined fashion to convey a set of instructions to the IPS. The IPS maintains the algorithms necessary to interpret these instructions and then performs the operations indicated by these instructions. These algorithms are stored in one of the IPS's databases (24, 26, FIG. 4) and can be placed in the database by an IPS User.

These instructions can also be extracted from the Recipient Address of the Inbound Message. For example, if an Inbound Message is sent to jeff@domain.com, the name ‘jeff’ can be used to perform certain actions as dictated by the IPS algorithms.

Recipient Address

This is a routing instruction within the Inbound Message (A, FIG. 4) and Outbound Processed Message (I, L, FIG. 4). This address can be composed of a 10-digit phone number, a US Short Code or an email address.

SMS

(Short Message Service) A text message service that enables short messages of generally no more than 140-160 characters in length to be keyed in and transmitted from a cell phone (M1, FIG. 4).

SMS/MMS Gateway

A relay system designed to send and receive SMS and MMS messages and route them to their destinations.

SMTP

(Simple Mail Transfer Protocol) The standard e-mail protocol on the internet and part of the (TCP/IP) protocol suite. SMTP defines the message format and the message transfer agent which stores and forwards the mail. This is the system designed to relay MIME messages to their destinations.

Space

This is a network accessible site similar to a personal web site where a User may maintain address books full of Contact Information, and personal content that they would like to share either publicly or privately only among Groups in their Address Book.

User

This is a person who accesses the IPS via a Mobile Device (see M1, FIG. 4) or a Web Browser (see 28, FIG. 4). A User will typically be associated with a specific 10 digit phone number which will act as a user name for accessing the IPS. A User may use the IPS to supply content via a Space, to other Users. A User may also manage other User's Spaces if the Spaces are public or if the User is on a private access list granted by the owner of the Space.

US Short Code

A 5 digit numeric code that can be used as a recipient address for messages sent from a Mobile Device.

### Dynamic Image Processing

The IPS monitors the incoming messages to the Recipient Address and upon receipt of a message, will then perform the Dynamic Image Processing (DIP).

Dynamic Image Processing is performed in one of a variety of ways:

The sender can send just a short message system (SMS) message which is then processed by the IPS and based on the instructions, will send-out a new message containing a modified image that originated from and resides in the IPS system and has been modified according to the sender's instructions. The recipient of the new message can be one or more mobile handset devices.

The sender can send a multi-media system (MMS) message, containing one or more media files, which is then processed by the IPS and, based on the instructions, sends out a message containing a dynamically modified image. The recipient of the new message can be one or more mobile handset devices.

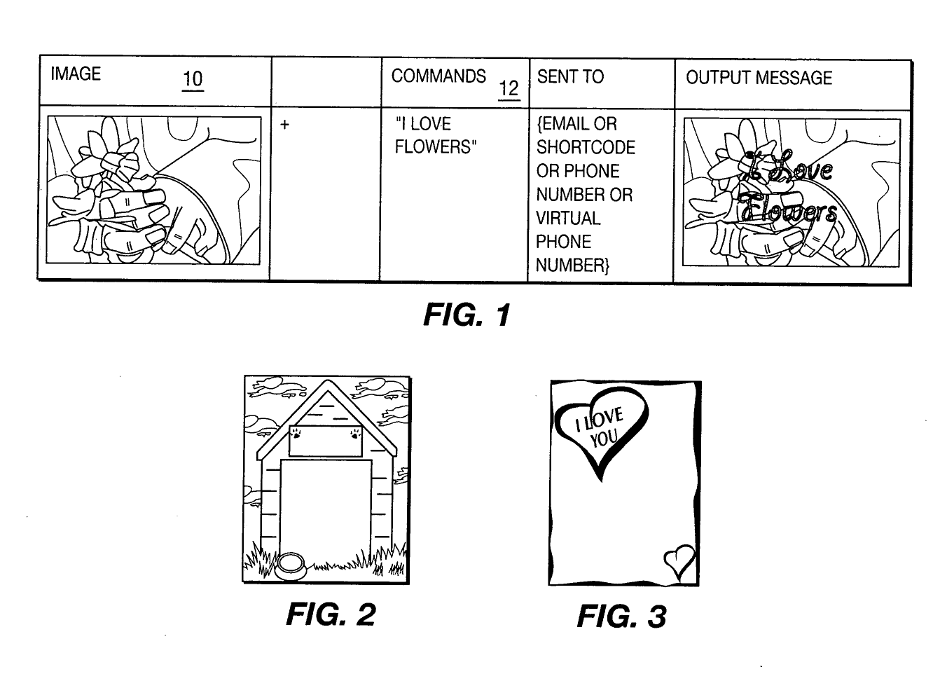

Making reference to FIG. 1, one example is an image 10 sent to the IPS together with an instruction that reads “I Love Flowers” to be merged with image 10 (see 12 in FIG. 1). The IPS then dynamically modifies the pixels of the image and inserts the text that reads “I Love Flowers”. The IPS then sends the new image to one or any number of receiving parties.

Another example is the sender sends two (2) photographs: one of a man's face and one of a woman's face and instructions to merge. The IPS morphs the images together and generates a new face and sends the new facial image to one or any number of receiving parties.

Message Routing

One of the unique aspects of the IPS is the ability for any number of users to have a shared Recipient Address that points to a unique graphic template on the IPS system. For example, User 1 may configure his (her) IPS account to accept messages at the address love@photocrank.com. When User 1 sends a message to love@photocrank.com, the IPS will super-impose FIG. 2 on top of the photograph enclosed in the message. On the other hand, User 2 may also decide to configure his (her) IPS account to accept messages at the address love@photocrank.com. When User 2 sends a message to love@photocrank.com, the IPS will super-impose FIG. 3 on top of the photograph that was enclosed in the message from User 2.

### GENERAL OVERALL DESCRIPTION OF THE METHOD AND APPARATUS

The system, as will be described in greater detail with reference to FIG. 4, comprises a minimum of one and preferably many wireless handsets. In addition to the handset(s), there is a centralized processing system designed to receive and process the contents of SMS, MMS and E-mail messages sent via wireless mobile devices.

The system enables a handset user to snap a photograph with the embedded digital camera in the handset, or use an existing media file presently stored on the handset. By enabling the user to email or text message the image to a centralized server address, identified by either an email address, a Short Code or a Phone Number, the server (i.e., IPS) retrieves the image and manipulates the image based on either predefined instructions available at the user's site or user supplied instructions, that reside in the message containing the image, or both.

In addition to the instructions already being stored in the central image processing system, the handset user can provide alpha-numeric encoded instructions via the subject line and message body portions of the SMS, email or MMS message. Upon receipt of the message, by the server, the server processes the instruction set and the media file and responds by sending the dynamically processed image to either the original handset user or additional handset users (or both) as specified by the server's configuration or by the instructions provided in the SMS or MMS message.

### DETAILED DESCRIPTION

Making reference to FIG. 4, an SMS, MMS or MIME Inbound Message is sent (A) from a Mobile Device M1, having the capability of taking (and/or receiving) and storing: still and/or video images and/or audio content, for example.

The message (A) is received by a cellular network (CN) servicing subscriber M1. The received message is sent (B) by the carrier to the Image Processing System (IPS) 20.

Message Processing—The message processing unit 22 of IPS 20 receives the message (C), extracts information from the message and transfers the appropriate information (D) to routing database 26.

Business logic unit 36 manages communication between routing database 26 (J) and multimedia database 24 (E) to route the message to the appropriate media content stored in the multi-media database 24, based upon either the instructions (i.e., site address) in the sender's message or just the instructions in the sender's message.

Routing Database 26 contains all the multimedia files that are used to enhance the photographs that get sent into the system from M1 and also contains the mapping of Recipient Addresses and their associated user accounts. FIG. 4 shows some representative addresses 26-1 through 26-6, it being understood that a much greater number of addresses are typically stored in routing database 26. One or more recipient addresses (see addresses 26-1 and 26-6) can access the same multi-media file in the database 24. In addition, depending on the originator of the message M1, one unique recipient address in routing database 26 can be mapped to two (or more) unique multimedia files in database 24.

Users of the system can access the databases 24, 26 via a Web Browser 28. For example, an end user, M2, represented in FIG. 4 by a personal computer (PC) or laptop or any device with similar capability, which, typically gains access to the web browser in the internet by one of a wired connection or a wireless channel, such as a hot-spot, wireless local area network (WLAN), wide area network (WAN) or the like, and which accesses (H) the web browser 28, employed to control how Recipient Addresses get mapped to multimedia files that are stored in database 24.

A subscriber sets up a site through browser 28. The subscriber accesses IPS 20 and views clip art, choosing one or more images, which may be templates such as are shown in FIGS. 2 and 3. The selected images are tagged by one of or both the subscriber's cell phone number and an “alias” selected by the subscriber, whereby the “tag” associates the selected clip art with the site. The subscriber may also set up special instructions such as “add the following message to the template”, specifying the font type and size. One or more of the words in the message may be omitted and the missing word or words are provided as part of a message sent from the subscriber's handset along with a snapped image to be modified. For example, the message may be “You're a great . . . ” and the missing word “mom” (or “friend” or some other word or words) is sent with the snapped image. The instructions may also include combining or morphing images in a given way, such as “convert image to black and white, rotate one-quarter turn and add a moustache, put bubbles around the template frame, add hearts, etc.” When the subscriber has set up an alias with instructions and images he (she) then sends the alias to IPS 20 with the snapped image. IPS 20 retrieves the instructions at the alias, retrieves the selected clip art associated with the subscriber's alias and manipulates the snapped image according to the instructions at the alias site. It should be understood that one user may set up more than one alias.

The business logic unit 36 manages communication with the web browser 28 and the internal business systems.

Images from database 24, selected by routing database 26 are sent (G) to the instruction processing unit 30 of IPS 20, which performs operations in accordance with stored algorithm(s) selected based on the instructions which either accompany the incoming message or reside in one of the addresses identified by Recipient Address accompanying the sender's inbound message (A).

The provisioning unit 32, accesses routing database 26, assembles headers and footers of the outbound message, which identify the recipient(s), logs the message into routing database 26 and sends the message (I) to the aggregation unit 34.

The aggregation unit 34 converts the message with the dynamically altered image(s) to a format appropriate for mobile handset reception and sends (L) the converted message to the cellular network CN which then sends the message (F) to the wireless handset of the recipient identified, for example, by the message header, the named recipient being, shown, for example, as the mobile unit of sender M1, it being understood that the recipient may be (and typically is) another mobile unit or units (not shown) in the same or different cellular network (not shown for purposes of simplicity).

1. A method employed by an image processing system (IPS), comprising:
a) receiving a message containing instructions and one form of multimedia content from a subscriber;
b) altering said one form of multimedia content in accordance with said instructions; and
c) sending the altered content to a recipient in accordance with said instructions.

2. The method of claim 1 wherein step (a) further comprises:
receiving said message from said subscriber over a wireless channel.

3. The method of claim 1 whereby the altering step (b) comprises:
receiving said message from a remote handset through a cellular network.

4. The method of claim 1 wherein the altering step (b) comprises:
combining an image with text.

5. The method of claim 1 wherein the altering step (b) comprises:
combining an image with another image.

6. The method claim 1 wherein the altering step (b) comprises:
combining an image with audio content.

7. The method of claim 1 wherein step (c) comprises:
transferring the altered content to a site accessible through the internet by a browser.

8. The method of claim 7 wherein the site is a public site accessible by anyone.

9. The method of claim 7 wherein the site is non-public and is accessible only by persons identified by instructions provided in said message.

10. A method employed by an image processing system (IPS), comprising:
a) receiving a message containing an image and instructions from a subscriber;
b) accessing a shared location to obtain a given multimedia content responsive to said instructions;
c) combining the received image with the accessed image; and
d) sending the combined images to a given destination identified in said instructions.

11. The method of claim 10 wherein step (d) comprises:
sending the combined images to a wireless handset of a recipient identified in said instructions.

12. The method of claim 11 wherein step (d) comprises:
sending the combined images to a location at said IPS accessible by a recipient.

13. The method of claim 10 wherein the destination is a location accessible through the internet by a web browser.

14. A method for manipulating multimedia content between and among subscribers, users and an image processing system (IPS), comprising:
a subscriber:
accessing a database in said IPS through the internet employing a web browser;
viewing clip art provided in said database;
selecting at least one image contained in said clip art. setting up and naming a site;
requesting the IPS to provide a tag associating the selected image with said site, whereby a future request for said image by means of wireless handset transmitted to the IPS is made by an instruction setting forth the name of the subscriber's site.

15. The method of claim 14 further comprising, the subscriber:
requesting the IPS to include instructions for manipulation of the selected image at the subscriber's site, whereby a future request for said image transmitted to the IPS by a wireless handset is made by an instruction setting forth the name of the subscriber's site.

16. The method of claim 14,
the subscriber:
requesting the IPS to set up the subscriber's site as a non-public site allowing only subscribers to access the site with a given password.

17. The method of claim 14, the subscriber:
requesting the IPS to set up the subscriber's site as a public site enabling anyone to access the site.

18. The method of claim 14, the subscriber:
sending a message from a wireless handset, said message including an image stored at said handset and instructions including the subscriber's site name;
said IPS:
retrieving the clip art image identified by the subscriber's site name; and
combining the image received from the subscriber with the clip art image according to the instructions.

19. An image processing system (IPS), comprising:
means for receiving a message containing instructions and one form of multimedia content from a subscriber;
means for altering said one form of multimedia content in accordance with said instructions; and
means for sending the altered content to a recipient in accordance with said instructions.

20. The IPS of claim 19 wherein said means for receiving further comprises:
means for receiving said message from said subscriber over a wireless channel.

21. The IPS of claim 19 wherein the means for altering further comprises:
means for receiving said message from a remote handset through a cellular network.

22. The IPS of claim 19 wherein the means for altering further comprises:
means for combining an image with text.

23. The IPS of claim 19 wherein the means for altering further comprises:
means for combining an image with another image.

24. The IPS of claim 19 wherein the means for altering further comprises:
means for combining an image with audio.

25. The IPS of claim 19 wherein the means for sending further comprises:
means for transferring the altered content to a site accessible through the internet by a browser.

26. The IPS of claim 25 wherein the site is a public site accessible by anyone.

27. The IPS of claim 25 wherein the site is non-public and is accessible only by persons identified by instructions provided in said message.

28. An image processing system (IPS), comprising:
means for receiving a message containing an image and instructions from a subscriber;
means for accessing a shared location to obtain a given multimedia content responsive to said instructions;
means for combining the received image with the accessed image; and
means for sending the combined images to a given destination identified in said instructions.

29. The IPS of claim 28 wherein the means for sending comprises:
means for sending the combined images to a wireless handset of a recipient identified in said instructions.

30. The IPS of claim 28 wherein the means for sending comprises:
means for sending the combined images to a location at said IPS accessible by a recipient.

31. The IPS of claim 28 wherein the destination is a location accessible through the internet by a web browser.

32. A network for manipulating multimedia content between and among subscribers, users and an image processing system (IPS), comprising:
a subscriber comprising:
means for accessing a database in said IPS through the internet employing a web browser;
means for viewing clip art provided in said database and comprising a plurality of images;
means for selecting at least one image contained in said clip art.
means for setting up and naming a site; and
means for requesting the IPS to associate the selected image with said site, whereby a future request for said image by means of wireless handset transmitted to the IPS is made by an instruction setting forth the name of the subscriber's site.

33. The network of claim 32, further comprising, the subscriber comprising:
means for requesting the IPS to include instructions for manipulation of the selected image at the subscriber's site, whereby a future request for said image transmitted to the IPS by a wireless handset is made by an instruction setting forth the name of the subscriber's site.

34. The network of claim 32,
the subscriber further comprising:
means for requesting the IPS to set up the subscriber's site as a non-public site allowing only subscribers to access the site with a given password.

35. The network of claim 32, the subscriber further comprising:
means for requesting the IPS to set up the subscriber's site as a public site enabling anyone to access the site.

36. The network of claim 32, the subscriber further comprising:
means for sending a message from a wireless handset, said message including an image stored at said handset and instructions including the subscriber's site name;
said IPS comprising:
means for retrieving the clip art image identified by the subscriber's site name; and
means for combining the image received from the subscriber with the clip art image according to the instructions.
